(19) United States
(12) Patent Application Publication
(10) Pub. No.: US 2021/0397875 A1
(43) Pub. Date: Dec. 23, 2021

(54) DEVICE AND METHOD FOR DISTINGUISHING AND COUNTING PERSONS AND OBJECTS

(71) Applicant: DILAX INTELCOM GMBH, 10559 Berlin (DE)

(72) Inventor: THOMAS RIEDLE, Berlin (DE)

(73) Assignee: DILAX INTELCOM GMBH, 10559 Berlin (DE)

(21) Appl. No.: 17/292,299

(22) PCT Filed: Nov. 8, 2019
(86) PCT No.: PCT/EP2019/080762

§ 371 Date: May 7, 2021

(30) Foreign Application Priority Data
Nov. 8, 2018 (DE) 10 2018 128 012.2

(51) Int. Cl. G06K 9/46; G06T 7/521; G06K 9/20; G06T 7/62; G06K 9/00; G01S 7/48; G01S 17/04

(52) U.S. Cl. CPC G06K 9/4661; G06T 7/521; G06K 9/2036; G06K 9/2054; G06T 7/62; G06T 2207/30196; G01S 7/4802; G01S 17/04; G06T 2207/10028; G06T 2207/10116; G06T 2207/30242; G06K 9/00362

(57) ABSTRACT

The invention relates to a method for distinguishing, detecting and counting persons and/or objects in facilities and/or vehicles for conveying persons and/or goods, with the method steps: emitting radiation from a radiation source, deflecting the radiation with an element for deflecting the radiation, generating a light pattern in a detection region, detecting the radiation backscattered by persons and/or objects situated in the detection region in a radiation detector, and counting the persons and/or objects in a counting region, wherein the counting region is arranged in a region between 30 cm in front of and 30 cm behind an entrance to facilities and/or to the vehicle for conveying persons and/or objects. The invention also relates to a corresponding device for performing the method.

The Invention relates to a method for distinguishing, detecting and counting persons and/or objects in facilities and/or vehicles for conveying persons and/or goods, with the following method steps: emitting radiation from a radiation source, deflecting the radiation with an element for deflecting the radiation, generating a light pattern in a detection region, and detecting the radiation backscattered by persons and/or objects situated in the detection region in a radiation detector, as well as a corresponding person and/or object counting device.

### PRIOR ART

Guiding flows of people, in particular in urban environments, requires an exact detection and a predictive analysis of the passenger flows. For this purpose, the persons getting into the vehicle (in particular bus, train, etc.) and getting out of the vehicle and the objects they may be carrying with them (suitcase, bicycle, etc.) must be exactly and reliably detected and classified. For this purpose, already known methods and sensors are employed in the environments mentioned.

A known solution uses multiple sensors at a distance of approx. 30 cm. Entering and exiting persons are counted by triangulation in the sensor. The counting events per pass are aggregated in a separate evaluation unit.

Another solution uses a counting sensor based on the time-of-flight (ToF) principle. Here, a region to be monitored is illuminated with a short modulated light pulse. A photonic mixer device evaluates the signal time of flight and provides signals that have a direct reference to 3D information. Counting data are generated from the algorithmic treatment of the 3D data.

Another known solution evaluates the intensity of the light reflected by persons and objects. Another employed solution uses two cameras which evaluate a stereoscopic image of the persons and objects. Another solution uses a counting sensor which actively works stereoscopically, i.e. uses a light source in addition to the stereo camera.

The systems and methods mentioned here have various disadvantages. Using multiple sensors is complex, therefore expensive and, due to their dimensions, cannot be integrated into every environment that should be monitored. The use of a short modulated light pulse requires a high energy content of the pulse in order to illuminate the region to be monitored sufficiently strongly so that a sufficient reflected brightness is available for the exposure of the PMD chip. This means the sensor needs a lot of energy. In particular the pulse characteristic in the electricity consumption must be managed with circuitry. In addition, due to the finite efficiency of the light sources, a considerable amount of heat energy is created. This makes complex thermal management necessary.

The detection of the reflection of the emitted light is dependent on the material of the reflector. Due to different clothing and hair, persons are very different in their reflection of light. With known devices, evaluating only light intensities due to reflection can lead to unreliable counting results.

Due to their principle, stereoscopic cameras are reliant on identifying unique features when comparing the two corresponding images. Usually, contrasts in the image that are caused by edges or outlines are used as a feature. If a scene is low contrast, this can lead to problems in the calculation of depth data. Too little ambient light or persons who blend in optically with the environment due to their clothing can be causes of lacking contrast. A lack of correct depth data can lead to erroneous counting.

Using light sources for large-area illumination of the region to be monitored can solve the problem of too little ambient light in the case of stereo cameras. The problem of low contrast in specific scenes is not solved by this.

It is therefore the object of the invention to provide a method with which efficient and cost-effective distinguishing of persons and objects, their direction of movement and their counting when getting into and getting out of a local public transportation vehicle is possible. Furthermore, it is an object of the invention to provide a corresponding sensor apparatus for performing the method.

The object is solved by the method according to claim 1. Further advantageous embodiments of the invention are set out in the dependent claims.

The method according to the invention for distinguishing, detecting and counting persons and/or objects in facilities and/or vehicles for conveying persons and/or goods has four method steps:

In the first method step, a radiation source emits radiation. The ambient light can contain sunlight or light from artificial illumination sources. It is therefore to be expected that radiation from the near infrared wavelength range is contained in the ambient light. Such ambient light can overlay the light that is emitted. As a solution, continuously radiated monochromatic light is used as the radiation. The wavelength is chosen such that it is remote from the maximum of the spectral radiation strength of the sun and common artificial light sources, but at the same time can still be received by affordable silicon-based detectors. Additionally, it is required that the radiation be invisible to the human eye. For the realization of the invention, light of the wavelength from 780 nm to 1000 nm is suitable. When using a spectrally selective detector, the invention thus works reliably under the ambient conditions in the mobile range.

In the second method step, the radiation is deflected by an element for deflecting the radiation. The radiation is collimated by a lens and guided vertically onto, for example, a diffractive optical element (DOE). DOEs have some advantages over beam shaping by, for example, masks. Beam parts with an intensity that is too low are not simply suppressed by a mask, but rather, due to the principle, the intensity of the beam is limited only by the diffraction efficiency of the diffractive structure. As a result, the beam energy efficiency can be taken advantage of.

In the third method step, a light pattern is generated in a detection region. The element for deflecting the radiation is structured such that a suitable light pattern is created behind the element for deflecting the radiation. In the context of the invention, any optical arrangement which generates a light pattern with the described properties can be used.

The projected light pattern consists of small, delimited, illuminated regions and of dark, i.e. non-Illuminated, regions. The illuminated regions can be abstracted in a good approximation as light points. The location of the light points can be described assuming the model of light beams originating from a central projection point in the radiation source.

The light of the light pattern projector falls from a central projection point into the spatial region to the monitored. The radiation detector is oriented such that its spatial field of vision is largely identical to the illuminated spatial region. The common spatial region is the detection region of the device for detecting, categorizing and counting persons and/or objects.

The detection region is described by the spatial angle of the central projection. Depending on the choice of the aperture, the detection region is described by suitable geometric figures, the geometric origins of which lie in the central projection point of the device for detecting, categorizing and counting persons and/or objects. With a rectangular aperture, it is the pyramid with a rectangular and even outline; with a round aperture, it is the straight circular cone. The spatial angle of the straight circular cone is: Ω=4π sin 2 (φ/4), wherein φ is the full beam angle. The spatial angle of the pyramid is: Ω=4 arcsin(sin(φx/2) sin(φy/2)), wherein φx and φy are the two full beam angles. For the use of the invention with the requirement of direction recognition, two light beams are sufficient. The two beams are slightly divergent from one another but detect predominantly the same spatial region. With this geometry, a spatial angle of at least Ω=0.006 sr can be detected. By using additional beams, the detection region can be extended up to the hemisphere. The spatial half below the plane of installation of the device for detecting, categorizing and counting persons and/or objects is then completely monitored; the spatial angle is 2π sr.

In the fourth method step, the radiation backscattered by persons and/or objects situated in the detection region is detected in a radiation detector. To carry out the invention, it is sufficient to choose the detection region such that at least one part of the human body of a person and/or one part of an object is detected in the defined spatial region.

In the fifth method step, the persons and/or objects in a counting region are counted. According to the invention, the counting region is arranged in a region between 30 cm in front of and 30 cm behind an entrance to facilities and/or to the vehicle for conveying persons and/or objects.

The counting region is a defined area or a defined space and part of the detection region. If, for example, the passage through a door portal (entrance) is to be monitored, the counting region can be defined as an area or space within the portal opening. According to the invention, the counting region then lies 30 cm in front of to 30 cm behind the opening of the door portal. In the general case of curved door portal areas and a curved counting region, the distance refers to the shortest distance between area and region. Moving persons and/or objects must completely pass through the counting region in order to trigger a counting event. In this manner, it is avoided that a counting event is generated despite the fact that the person or the object does not enter the facility or the vehicle at all because they, for example, only want to ascertain if a seat is free and during this process come into contact with the counting region.

Facilities and/or vehicles for conveying persons and/or goods in the context of this invention can be train stations, stops, ports, airports or parts or regions thereof, as well as buses, trains, metro trains, suburban trains, ships and aircraft as well as any other facility or part of a facility as well as vehicles of any type.

An entrance in the context of this invention is a boundary area or a boundary volume in an opening between the interior of a facility and/or of a vehicle for conveying persons and/or goods and its outer side.

In a further embodiment according to the invention, the light pattern carries a code which establishes uniqueness. This is ensured, for example, by a specific arrangement of the light points of the light pattern, in which each point of the light pattern has an environment (submatrix) of light points uniquely assigned to it.

In a further aspect of the invention, the counting region is arranged in a region between 20 cm in front of and 20 cm behind an entrance to facilities and/or to the vehicle for conveying persons and/or objects and preferably in a region between 10 cm in front of and 10 cm behind an entrance to facilities and/or to the vehicle for conveying persons and/or objects. In this manner, account is taken of the spatial circumstances in the region of the counting region.

In a further embodiment of the invention, the counting region comprises a volume which is defined in space and is at least partially part of the detection region. A counting event occurs when moving persons and/or objects enter the counting region or exit the counting region.

In a further aspect of the invention, the counting region comprises a counting area which is defined in space and intersects the detection region. Location and extension of the counting area are variable and can be adapted to the spatial conditions. If, for example, the passage through a door portal is to be monitored, the counting area can be defined as a plane running parallel to the portal opening. A counting event occurs when moving persons and/or objects enter the counting area or exit the counting area.

In a further design of the invention, the counting region comprises two counting areas which are defined in space and intersect the detection region. Location and extension of the counting area are variable and can be adapted to the spatial conditions. Usually, the two counting areas are arranged parallel to one another and spaced apart from one another in the detection region. A counting event occurs when moving persons and/or objects enter one of the counting areas or exit one of the counting areas.

In a further embodiment of the invention, a first counting area faces a vehicle interior and a second counting area faces the vehicle exterior. A counting event occurs when a person and/or an object enters the first counting area or exits the second counting area. In this manner, the reliability of the counting is increased in that both counting areas must be passed through.

In a further embodiment of the invention, the location of the counting region and/or of the counting area is chosen depending on the type of the recognized object. The location of the counting region and/or of the counting area is in particular dependent on the extension of the recognized object perpendicularly to the counting region and/or to the counting area. Thus, the location of the counting region and/or the counting area is different in each case when the object is recognized, for example, as a bicycle than when the object is recognized, for example, as a person. A bicycle usually has a larger extension perpendicular to the counting region and/or to the counting area than a person. In the case of a bicycle, the location of the counting region and/or of the counting area is shifted such that a counting event occurs only when a longer region of the bicycle enters the counting region or the counting area, respectively, perpendicularly to the counting region and/or to the counting area.

In a further embodiment of the invention, a light pattern is detected in the detection region. Each person and/or object situated in the detection region leads to a changed light pattern compared to the light pattern originally generated in the detection region. These light patterns changed by persons and/or objects are detected.

In a further design of the invention, a movement of the light pattern is detected in the detection region. The imaginary line between the optical axis of the radiation source and the optical axis of the radiation detector is referred to as the baseline. If a person enters the detection region over time, the radiation detector observes a movement of parts of the generated light pattern along the baseline.

In a further embodiment of the invention, a shift of the light pattern is detected in the detection region. The detected light patterns are compared with the projected light pattern. For small image regions which have experienced a shift in relation to the generated light pattern, the shift is detected.

In a further embodiment of the invention, the length of the shift is calculated. The detected light patterns are compared with the projected light pattern. For small image regions which have experienced a shift in relation to the generated light pattern, a shift is detected and its length calculated.

In a further embodiment of the invention, a depth value is determined from the length of the shift. A depth value can be calculated for a small image region from the length shift on the basis of the geometric relationships. A 3D point cloud for further evaluation is provided as the result. Information about the scene in the detection region, including persons and objects present, is represented by the depth values of the 3D point cloud. Persons or objects have a characteristic, three-dimensional shape in space.

In a further design of the invention, the detected, synchronously shifted light patterns are compared with characteristic known patterns. The known patterns are, for example, stored in a memory. The synchronously shifted detected light patterns are compared with these known patterns in order to identify whether the synchronously shifted detected light patterns are persons and/or objects.

In a further embodiment of the invention, the light pattern is assigned to an object type. An object type is, for example, a person or a body part of a person, for example the face, or also an object such as, for example, a suitcase, bicycle, etc.

In a further embodiment of the invention, a characteristic point is determined for the assigned light pattern. The characteristic point computationally represents the synchronously shifted light pattern. In a further aspect of the invention, the characteristic point is determined with the aid of the center of gravity method. Other methods are also conceivable.

In a further design of the invention, a counting event is triggered when the light pattern and/or the characteristic point touches a counting region. Over time, a series of such characteristic points, which form a trajectory with a known directional progression, are created by evaluating many data. If the trajectory intersects the counting region, a counting event is generated.

In a further embodiment of the invention, the direction of movement of the light pattern and/or of the characteristic point is detected. Through this embodiment, it can be recognized whether a person and/or the object enters or exits the facility and/or the vehicle.

In a further embodiment of the invention, the counting event is classified using the direction of movement of the light pattern and/or of the characteristic point on the basis of predefined properties. If many persons and/or objects enter the facility and/or the vehicle, the counting event can be classified, for example, in regard to an imminent overfilling of the vehicle. Underutilization can also be detected. In this manner, the user obtains statistical data about the capacity utilization or the use of the facility and/or of the vehicle over a period of time of any desired length.

In a further design of the invention, the method is suitable for distinguishing, detecting and counting persons and objects in facilities and/or vehicles for conveying persons and/or goods.

In a further embodiment of the invention, the beam density ρₛ is between 5*10²/4*π sr⁻¹ and 10⁶/4*π sr⁻¹. The light pattern and/or the point density of the generated light pattern is to be chosen such that the generated light pattern in small image sections along the direction of shift of the persons and/or objects is unique at any possible position. At the same time, in contrast, the generated data volume should be as low as possible.

It has been shown that, for typical operation in vehicles for conveying persons and/or goods, the most favorable point density of the light pattern is one that corresponds to a beam density ρₛ of at least 5*10²/4*π sr⁻¹ and a maximum of 10⁶/4*π sr⁻¹, depending on the distance of the persons and/or objects to be detected or of the detection region from the beam source.

In a further embodiment of the invention, the beam density ρₛ is at least 1*10³/4*π sr⁻¹, preferably 5*10³/4*π sr⁻¹ and particularly preferably 1*10⁴/4*π sr⁻¹. The light pattern and/or the point density of the generated light pattern is to be chosen such that the generated light pattern in small image sections along the direction of shift of the persons and/or objects is unique at any possible position. At the same time, in contrast, the generated data volume should be as low as possible.

It has been shown that, for typical operation in vehicles for conveying persons and/or goods, the most favorable point density of the light pattern to choose is one that corresponds to a beam density ρₛ of at least 1*10³/4*π sr⁻¹ and particularly preferably 1*10⁴/4*π sr⁻¹, depending on the distance of the persons and objects to be detected or of the detection region.

In a further aspect of the invention, the beam density ρₛ is maximally 5*10⁵/4*π sr⁻¹, preferably 1*10⁵/4*π sr⁻¹ and particularly preferably 5*10⁴/4*π sr⁻¹. The light pattern and/or the point density of the generated light pattern is to be chosen such that the generated light pattern in small image sections along the direction of shift of the persons and/or objects is unique at any possible position. At the same time, in contrast, the generated data volume should be as low as possible. It has been shown that, for typical operation in vehicles for conveying persons and/or goods, the most favorable point density of the light pattern is one that corresponds to a beam density ρₛ of maximally 1*10⁵/4*π sr⁻¹ and particularly preferably 5*10⁴/4*π sr⁻¹, depending on the distance of the persons and objects to be detected or of the detection region from the beam source.

The object is also solved by the device according to claim 23. Further advantageous embodiments of the invention are set out in the dependent claims.

The device according to the invention for detecting, categorizing and counting persons and/or objects in facilities and/or vehicles for conveying persons and/or objects has a radiation source, a radiation detector and an element for deflecting the radiation leaving the radiation source.

The person- and/or object-counting device is suitable for counting in a counting region persons and/or objects situated therein. The counting region is a sub-region of the detection region and is arranged at least partially in a region between 30 cm in front of and 30 cm behind an entrance to the facilities and/or to the vehicle for conveying persons and/or objects.

The radiation source generates continuous monochromatic laser radiation with a wavelength in the range from 780 nm to 1000 nm. According to the invention, the element for deflecting the radiation leaving the radiation source is configured such that it is suitable for generating a light pattern in a detection region with a beam density of 5*10²/4*π sr⁻¹≤ρₛ≤10⁸/4*π sr⁻¹. The projected light pattern consists of small, delimited, illuminated regions and of dark, i.e. non-Illuminated, regions. The illuminated regions can be abstracted in a good approximation as light points. The location of the light points can be described assuming the model of light beams originating from a central projection point in the radiation source.

An important feature of the invention is the monitoring of a spatial region. The light of the light pattern projector falls from a central projection point into this spatial region. The radiation detector is oriented such that its spatial field of vision is largely identical to the illuminated spatial region. The common spatial region is the detection region of the device for detecting, categorizing and counting persons and/or objects.

The radiation source and optical elements generate the desired light pattern to be projected. One possible embodiment uses a laser diode as the radiation source, a collimator lens and a diffractive optical element (DOE). Along with the objective and the bandpass filter, the image sensor forms the radiation detector.

In a further aspect of the invention, the device for detecting, categorizing and counting persons and/or objects has an interface to a control and/or evaluation unit.

In a further embodiment of the invention, the device for detecting, categorizing and counting persons and/or objects has a control and/or evaluation unit. The control and evaluation unit has a memory as well as a computing unit.

In a further design of the invention, the radiation detector is suitable for detecting radiation of the light pattern backscattered by persons and/or objects in the detection region. A bandpass filter installed in the radiation detector is only permeable to light in a narrow spectral window. The central wavelength of the bandpass filter corresponds to the wavelength of the light emitted by the radiation source. This prevents light of other wavelengths from exposing the image sensor. By using the radiation source, the device for detecting, categorizing and counting persons and/or objects actively provides light and can also work in dark environments.

In a further embodiment of the invention, the control and/or evaluation unit is suitable for executing a program which assigns an object type to the light patterns on the basis of the light patterns backscattered by the persons and/or objects in the detection region. An object type is, for example, a person or a body part of a person, for example the face, or also an object such as, for example, a suitcase, bicycle, etc.

In a further embodiment of the invention, the control and/or evaluation unit is suitable for executing a program which follows the shift of persons and/or objects with regard to their direction and/or length on the basis of the backscattered light patterns.

Information about the scene in the detection region, including persons and objects present, is represented by the depth values of the 3D point cloud. Persons or objects have a characteristic, three-dimensional shape in space. A suitable program, for example a recognition algorithm, searches for parts of such characteristic shapes in the data of the 3D point cloud. If there is a match, a shape is detected. The position of a specific person or of a specific object can be abstracted by means of a characteristic point, which is determined, for example, by means of the center of gravity method.

Over time, a series of such characteristic points, which form a trajectory with a known directional progression, is created by evaluating many data from the radiation detector. From the direction of the trajectory it can be determined whether the person is getting into the vehicle or getting out of the vehicle, or is entering or exiting the facility. The same principle can be applied for objects, for example for bicycles or suitcases, that are brought into the detection region.

In a further embodiment of the invention, the device for detecting, categorizing and counting persons and/or objects is suitable for detecting the touching of a light pattern with a counting region situated in the detection region. Information about the scene in the detection region, including persons and objects present, is represented by the depth values of the 3D point cloud. The position of a specific person or of a specific object can be abstracted by means of a characteristic point, which is determined, for example, by means of the center of gravity method. If the trajectory intersects a predefined area in the space, the counting region, a counting event is generated.

In a further embodiment of the invention, the counting region comprises a volume which is predefined in space and is at least partially part of the detection region. A counting event occurs when moving persons and/or objects enter the counting region or exit the counting region.

In a further aspect of the invention, the counting region comprises a counting area which is defined in space and intersects the detection region. Location and extension of the counting area are variable and can be adapted to the spatial conditions. If, for example, the passage through a door portal is to be monitored, the counting area can be defined as a plane running parallel to the portal opening. A counting event occurs when moving persons and/or objects enter the counting area or exit the counting area.

In a development of the invention, the counting region comprises at least two planes, the location of which is predefined. Location and extension of the counting areas are variable and can be adapted to the spatial conditions. Typically, two counting areas arranged parallel to one another are used. The person or the object must then move at least partially through one counting area and also at least partially penetrate the second area again with a time delay. A counting event is only triggered once the resulting passage is detected.

In a further design of the invention, the counting region is arranged in a region between 30 cm in front of and 30 cm behind the entrance of the facility and/or of the vehicle for conveying persons and/or objects.

In a further aspect of the invention, the counting region is arranged in a region between 20 cm in front of and 20 cm behind the entrance of the facility and/or of the vehicle for conveying persons and/or objects and preferably in a region between 10 cm in front of and 10 cm behind the entrance of the facility and/or of the vehicle for conveying persons and/or objects.

In a further embodiment of the invention, the generated beam density ρₛ is at least 1*10³/4*π sr⁻¹, preferably 5*10³/4*π sr⁻¹ and particularly preferably 1*10⁴/4*π sr⁻¹. The light pattern and/or the point density of the generated light pattern is to be chosen such that the generated light pattern in small image sections along the direction of shift of the persons and/or objects is unique at any possible position. At the same time, in contrast, the generated data volume should be as low as possible.

It has been shown that, for typical operation in vehicles for conveying persons and/or goods, the most favorable point density of the light pattern is one that corresponds to a beam density ρₛ of at least 1*10³/4*π sr⁻¹ and particularly preferably 1*10⁴/4*π sr⁻¹, depending on the distance of the persons and objects to be detected or of the detection region.

In a further aspect of the invention, the generated beam density ρₛ is at most 5*10⁵/4*π sr⁻¹, preferably 1*10⁵/4*π sr⁻¹ and particularly preferably 5*10⁴/4*π sr⁻¹. The light pattern and/or the point density of the generated light pattern is to be chosen such that the generated light pattern in small image sections along the direction of shift of the persons and/or objects is unique at any possible position. At the same time, in contrast, the generated data volume should be as low as possible. It has been shown that, for typical operation in vehicles for conveying persons and/or goods, the most favorable point density of the light pattern is one that corresponds to a beam density ρₛ of maximally 1*10⁵/4*π sr⁻¹ and particularly preferably 5*10⁴/4*π sr⁻¹, depending on the distance of the persons and objects or the detection region.

Exemplary embodiments of the method according to the invention for distinguishing, detecting and counting persons and/or objects in facilities and/or vehicles for conveying persons and/or goods and the device according to the invention for detecting, categorizing and counting persons and/or objects in facilities and/or vehicles for conveying persons and/or objects are shown schematically simplified in the drawings and are explained in greater detail in the following description.

The figures show:

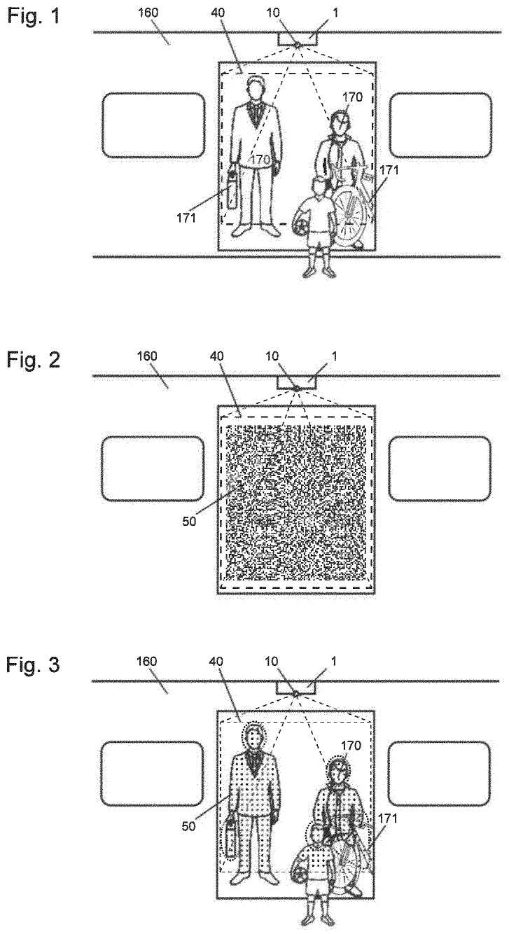

FIG. 1 Arrangement of the device according to the invention for detecting, categorizing and counting persons and/or objects and location of the detection region.

FIG. 2 Location of the detection region with generated light pattern.

FIG. 3 Detection of persons and/or objects in the detection region.

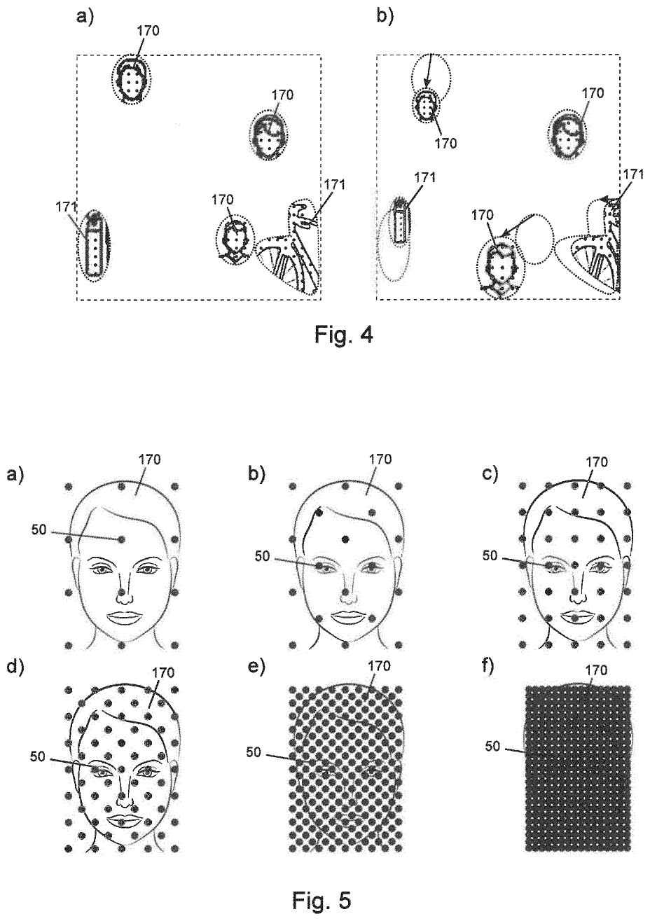

FIG. 4a Generated 3D point cloud of the persons and/or objects in the detection region.

FIG. 4b Generated 3D point cloud when the persons and/or objects in the detection region are moving.

FIG. 5a Determination of the suitable density of the pattern points of the light pattern generated by the radiation source, point density too low.

FIG. 5b Determination of the suitable density of the pattern points of the light pattern generated by the radiation source, point density suitable.

FIG. 5c Determination of the suitable density of the pattern points of the light pattern generated by the radiation source, point density suitable.

FIG. 5d Determination of the suitable density of the pattern points of the light pattern generated by the radiation source, point density suitable.

FIG. 5e Determination of the suitable density of the pattern points of the light pattern generated by the radiation source, point density suitable.

FIG. 5f Determination of the suitable density of the pattern points of the light pattern generated by the radiation source, point density too high.

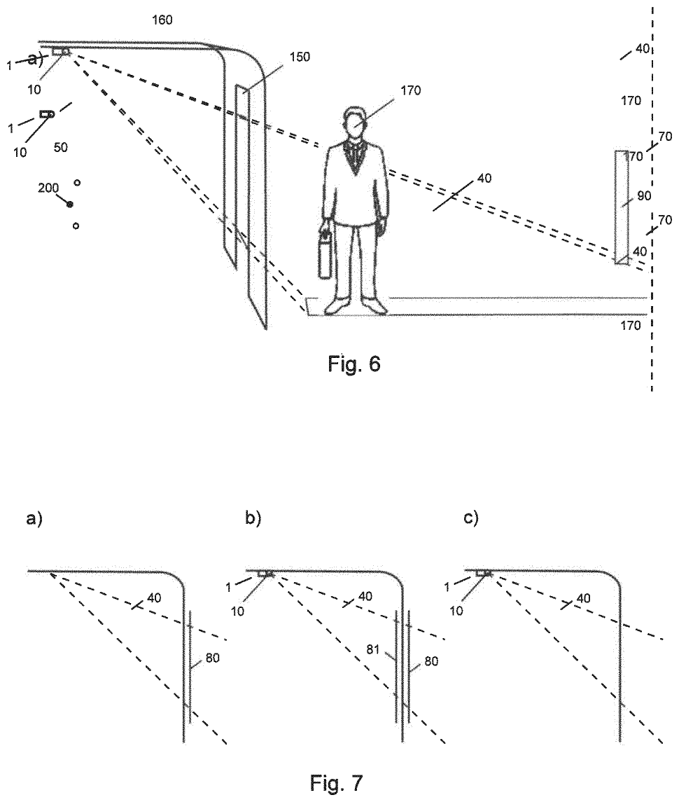

FIG. 6 Detection region for detecting, categorizing and counting persons and/or objects of the device for detecting, categorizing and counting persons and/or objects on a door portal.

FIG. 7a Orientation and location of a counting area on a door portal.

FIG. 7b Orientation and location of two parallel counting areas on a door portal.

FIG. 7c Orientation and location of a counting volume on a door portal.

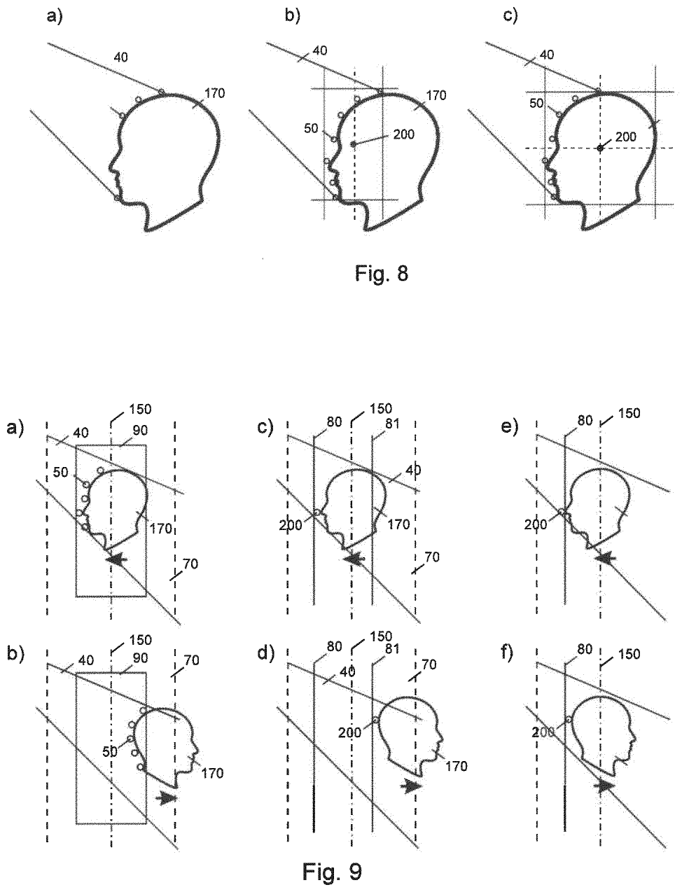

FIG. 8a Side view of the location of the characteristic point, determination of the point with the smallest distance to the device for detecting, categorizing and counting persons and/or objects.

FIG. 8b Side view of the location of the characteristic point, determination of the area center of gravity.

FIG. 8c Side view of the location of the characteristic point, determination of the volume center of gravity.

FIG. 9a Side view of differently designed counting regions and the generation of a counting event when a person enters, counting region configured as a counting volume.

FIG. 9b Side view of differently designed counting regions and the generation of a counting event when a person exits, counting region configured as a counting volume.

FIG. 9c Side view of differently designed counting regions and the generation of a counting event when a person enters, counting region with two counting areas.

FIG. 9d Side view of differently designed counting regions and the generation of a counting event when a person exits, counting region with two counting areas.

FIG. 9e Side view of differently designed counting regions and the generation of a counting event when a person enters, counting region with one counting area.

FIG. 9f Side view of differently designed counting regions and the generation of a counting event when a person exits, counting region with one counting area.

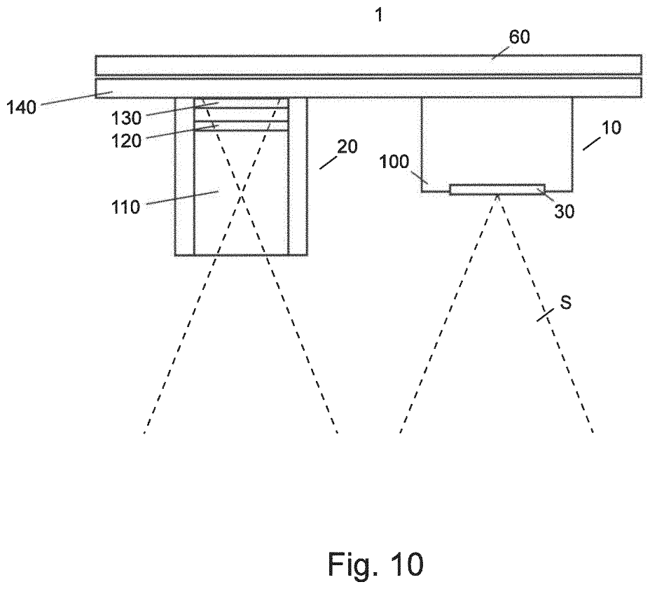

FIG. 10 Structure of an exemplary embodiment of the device for detecting, categorizing and counting persons and/or objects.

FIG. 1 shows a typical scene in the region for getting into and getting out of a vehicle for conveying persons, for example a public passenger transportation vehicle. Persons of different body size and thus different volumes characterize this region; in addition, the persons wear different clothing and have different hair colors and hairstyles. There are therefore different in their reflection of light. The persons may also carry objects such as bags, suitcases, bicycles, etc. with them. These persons and the objects are simultaneously detected, categorized and counted by the device according to the invention for detecting, categorizing and counting persons and/or objects 1.

The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces.

The device for detecting, categorizing and counting persons and/or objects 1 is situated, in all the exemplary embodiments shown here, in the upper region of the region for getting into and getting out of the facility or the vehicle.

To describe the location of the device for detecting, categorizing and counting persons and/or objects 1 in space, the central projection point of the radiation source 10 is used and the location of the optical axis of the radiation source 10, meaning the straight line which is perpendicular to the element for deflecting the radiation 30 and contains the central projections point. If the elements of the device for detecting, categorizing and counting persons and/or objects 1 are firmly connected to one another, the geometric location of the device for detecting, categorizing and counting persons and/or objects 1 is thus also clearly defined in space. In order to ensure the functionality of the device for detecting, categorizing and counting persons and/or objects 1, the projection point lies between 1.7 m (minimum) and 20 m (maximum) vertically above the floor of the vehicle. In typical vehicles, the projection point lies between 1.8 m to 3 m vertically above the floor of the vehicle.

To distinguish, detect and count persons and/or objects in vehicles for conveying persons and/or goods, the radiation source 10 of the device for detecting, categorizing and counting persons and/or objects 1 emits radiation S in the first method step. The ambient light can contain sunlight or light from artificial illumination sources. It is therefore to be expected that radiation from the near infrared wavelength range is contained in the ambient light. Such ambient light can overlay the light that is emitted by the radiation source 10. As a solution, monochromatic laser radiation and a spectrally selective detector is used. The wavelength is chosen such that the radiation is invisible to the human eye. When choosing the wavelength, it must be ensured that the image sensor of the radiation detector 20 has a sufficiently high quantum efficiency to generate enough photoelectrons. For the realization of the invention, light of the wavelength from 780 nm to 1000 nm is suitable. The invention thus works reliably under the ambient conditions in the mobile range.

The laser radiation S is collimated by a lens and guided perpendicularly onto the element for deflecting the radiation 30. The element for deflecting the radiation 30 is usually a diffractive optical element (DOE), which is structured such that, in the second method step for distinguishing, detecting and counting persons and/or objects in vehicles for conveying persons and/or goods, a suitable detection region 40 having a counting area 80 is created behind the DOE 30. In the context of the invention, however, any optical arrangement which generates a light pattern 50 can also be used. In this exemplary embodiment, the counting area 80 is chosen such that it coincides with the door cut-out of the region for getting in and getting out.

FIG. 2 shows in an exemplary manner the light pattern 50 generated by the radiation source 10 of the device for detecting, categorizing and counting persons and/or objects 1 in the detection region 40. For better illustration, the persons and objects are removed from this representation.

The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces. The radiation source 10 generates continuous monochromatic laser radiation S with a wavelength in the range from 780 nm to 1000 nm.

In the third method step for distinguishing, detecting and counting persons and/or objects in facilities and/or vehicles for conveying persons and/or goods, the device for detecting, categorizing and counting persons and/or objects 1 generates a light pattern 50. The projected light pattern 50 consists of small, delimited, illuminated regions and of dark, i.e. non-illuminated, regions. The illuminated regions can be abstracted in a good approximation as light points. The location of the light points can be described assuming the model of light beams originating from a central projection point in the radiation source 10.

The generation of 3D depth data from a spatial region is central to the invention. In order to obtain such 3D data, the triangulation principle is expanded into the third spatial dimension. In order to obtain clear depth data, the correspondence problem between features of the detected images from the radiation detector 20 and the features that are projected into the space must be solved. The light pattern 50 provides the features required to solve the correspondence problem.

The light pattern 50 is designed in this case such that the projected light pattern 50 in small image sections along the direction of shift of the persons and/or objects is unique at any possible position.

The density of the pattern points determines the resolution of the detected persons and objects. Since the pattern points are created through central projection, the number of the light beams per spatial angle is a measure for the resulting point density. The spatial angle Ω is defined as the area content A of a sub-area of a sphere surface, divided by the square of the radius r of the sphere Ω=A/r². Here, the center point of the sphere lies in the central projection point. N is the number of light beams that fall into the detection region. These light beams penetrate a sphere surface with the radius 1 m and the spatial angle 4π sr. Thus, the beam density in the detection region 40 of ρₛ=N/4π sr⁻¹ results. In the simplest case, two light beams are sufficient for counting persons. The beam density is then ½π sr⁻¹. In order to obtain more data, up to 10⁶ points in the detection region 40 can be used. The beam density is then 10⁶/4π sr⁻¹.

The light pattern has a code which establishes uniqueness. This is ensured here by a specific arrangement of the light points of the light pattern, in which each point of the light pattern has an environment (submatrix) of light points uniquely assigned to it.

FIG. 3 shows the detection of persons and/or objects in the detection region 40. The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces. The radiation source 10 generates continuous monochromatic laser radiation S with a wavelength in the range from 780 nm to 1000 nm.

In the fourth method step for distinguishing, detecting and counting persons and/or objects in facilities and/or vehicles for conveying persons and/or goods, the backscattered radiation from persons and/or objects situated in the detection region 40 is detected in the radiation detector 20. The imaginary line between the optical axis of the radiation source 10 and the optical axis of the radiation detector 20 is referred to as the baseline. If a person enters the detection region 40 over time, the radiation detector 20 observes a shift of parts of the light pattern 50 along the baseline. That program that is executed on the control and evaluation apparatus 60 compares the detected images from the radiation detector 20 with the projected light patterns 50. For small image regions which have experienced a shift in relation to the known light pattern 50, the program calculates the length of the shift, known as the disparity. Since the light pattern 50 on small image regions along the baseline is unique, exactly one disparity is found for each image region. A depth value can be calculated for a small image region from the disparity on the basis of the geometric relationships. In the result, a 3D point cloud 190 is now provided for further evaluation. Optionally, a coded light pattern (see FIG. 2) can also be used.

FIG. 4 shows the 3D point cloud 190 when the persons and/or objects in the detection region 40 are moving. The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces. The radiation source 10 generates continuous monochromatic laser radiation S with a wavelength in the range from 780 nm to 1000 nm.

Information about the scene in the detection region 40, including persons and objects present, is represented by the depth values of the 3D point cloud 190 (FIG. 4a). Persons or objects have a characteristic, three-dimensional shape in space. A suitable program, for example a recognition algorithm, searches for parts of such characteristic shapes in the data of the 3D point cloud 190. If there is a match, a shape is detected. The position of a specific person or of a specific object can be abstracted by means of a characteristic point 200, which is determined, for example, by means of the center of gravity method.

Over time, a series of such characteristic points 200, which form a trajectory with a known directional progression (FIG. 4b), are created by evaluating many data from the radiation detector 20. If the trajectory intersects a predefined area in the space, the counting area 80, a counting event is generated. From the direction of the trajectory it can be determined whether the person is getting into the vehicle or getting out of the vehicle. The same principle can be applied for objects, for example for bicycles or suitcases, that are brought into the detection region 40 and cross the counting area 80. Optionally, a coded light pattern (see FIG. 2) can also be used.

FIG. 5 illustrates the determination of the suitable density of the pattern points of the light pattern 50 generated by the radiation source 10. The number of pattern points shown in this figure show only a tendency, not an absolute number. The point density of the light pattern 50 is to be chosen such that the projected light pattern 50 in small image sections along the direction of shift of the persons and/or objects is unique at any possible position. In addition, the recognition algorithm must recognize characteristic shapes of persons and/or objects reliably. At the same time, in contrast, the generated data volume in the control and evaluation apparatus 60 should be as low as possible. Under these mentioned conditions, the selected point density of the light pattern 50, shown in FIG. 5a, is too low. Although the generated data volume is low, a clear categorization of the person is not possible, nor a reliable recognition of the person. In contrast, the selected point density of the light pattern 50, shown in FIG. 5f, is too high. On the one hand, the individual points of the light pattern can no longer be distinguished by the detector, and on the other hand, the amounts of data to be processed are so large that a considerably more powerful control apparatus and memories with larger capacities would be required and would thus lead to considerably higher costs.

It has been shown that, for typical operation in vehicles for conveying persons and/or goods, the most favorable point density of the light pattern 50 is one that corresponds to a beam density ρₛ of at least 1*10³/4*π sr⁻¹ and maximally 5*10⁴/4*π sr⁻¹, depending on the distance of the device for detecting, categorizing and counting persons and/or objects 1 from the persons and objects to be detected or the detection region 40. Illustrations of these point densities of the light pattern 50 are shown in FIG. 5b-e. For the sake of simplicity, regular light patterns are shown in FIG. 5a-f. Optionally, however, a coded light pattern (see FIG. 2) can also be used.

FIG. 6 shows the detection region 40 for detecting, categorizing and counting persons and/or objects 1 of the device for detecting, categorizing and counting persons and/or objects on a door portal 150 of a facility for public passenger transportation. The device for detecting, categorizing and counting persons and/or objects 1 is situated in the upper region at a distance to the door portal 150.

The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces. The radiation source 10 generates continuous monochromatic laser radiation S with a wavelength in the range from 780 nm to 1000 nm.

An Important feature of the invention is the monitoring of a spatial region. The light of the light pattern projector 100 falls from a central projection point into this spatial region. The radiation detector 20 is oriented such that its spatial field of vision is largely identical to the illuminated spatial region. The common spatial region is the detection region 40 of the device for detecting, categorizing and counting persons and/or objects 1.

The detection region 40 is described by the spatial angle of the central projection. Depending on the choice of the aperture, the detection region 40 is described by suitable geometric figures, the geometric origins of which lie in the central projection point of the device for detecting, categorizing and counting persons and/or objects 1. With a rectangular aperture, it is the pyramid with a rectangular and even outline; with a round aperture, it is the straight circular cone. The spatial angle of the straight circular cone is: Ω=4π sin 2 (φ/4), wherein φ is the full beam angle. The spatial angle of the pyramid is: Ω=4 Arcsin (sin(φx/2) sin(φy/2)), wherein φx and φy are the two full beam angles. For the use of the invention with the requirement of direction recognition, two light beams are sufficient. The two beams are slightly divergent from one another but detect predominantly the same spatial region. With this geometry, a spatial angle of at least Ω=0.006 sr can be detected. By using additional beams, the detection region 40 can be extended up to the hemisphere. The spatial half below the plane of installation of the device for detecting, categorizing and counting persons and/or objects 1 is then completely monitored; the spatial angle is 2π sr. To carry out the invention, it is sufficient to choose the detection region 40 such that at least one part of the human body of a person and/or one part of an object is detected in the defined detection region 40.

The orientation and location of the counting areas 80, 81 or of the counting volume 90 is shown in FIG. 7. The device for detecting, categorizing and counting persons and/or objects 1 is situated in the upper region at a distance to the door portal 150. The device for detecting, categorizing and counting persons and/or objects 1 has a radiation source 10, an element for deflecting the radiation 30, and a radiation detector 20. In addition, an electronic control and evaluation apparatus 60 is installed in or within communication range of the device for detecting, categorizing and counting persons and/or objects 1, which are connected to one another by means of interfaces. The radiation source 10 generates continuous monochromatic laser radiation S with a wavelength in the range from 780 nm to 1000 nm.

A counting area 80 is a defined area in the detection region 40 (FIG. 7a). If, for example, the passage through a door portal 150 is to be monitored, the counting area 80 can be defined as a plane parallel to the portal opening. The counting plane 80 then preferably lies 10 cm in front of and 10 cm behind the opening of the door portal 150. In order to monitor the door portal 150 in a suitable manner, distances of the counting plane 80 from the opening of the door portal 150 of up to 30 cm are advantageous.

In the context of the invention, distances of the counting plane 80 of maximally 250 cm in front to 250 cm behind the opening of the door portal are also possible. In the general case of curved door portal areas and curved counting areas 80, 81, the distance refers to the shortest distance between the areas. In the context of the invention, at least one counting area 80 which intersects the detection region 40 is defined. Moving persons and/or objects must at least partially pass through the counting area 80 in order to trigger a counting event.

In order to increase the reliability of the counting, two (FIG. 7b) or more counting areas 80, 81 can also be used. Typically, two counting areas 80, 81 arranged parallel to one another are used. The person or the object must then move at least partially through one counting area 80, 81 of the counting volume (FIG. 7c) defined by the two counting areas 80, 81 and also at least partially penetrate the second surface again with a time delay. A counting event is only triggered once the resulting passage is detected.

FIG. 8 shows a side view of the location of the characteristic point 200, which represents the position of a person or of an object, using different algorithms for its determination from the depth values of the 3D point cloud 190.

In the simplest case, the characteristic point 200 having the smallest distance from the device for detecting, categorizing and counting persons and/or objects 1 is determined from the points of the 3D point cloud 190 for representing a person or an object (FIG. 8a).

The characteristic point 200 can also be determined by a center of gravity method (FIG. 8b, c). The characteristic point 200 then lies within the space of the volume taken up by the person or by the object. When determining the surface center of gravity (FIG. 8b) of the points of the 3D point cloud 190, the characteristic point 200 lies at a smaller distance from the device for detecting, categorizing and counting persons and/or objects 1 as when the volume center of gravity is determined (FIG. 8c).

FIG. 9 shows a side view of differently designed counting regions (70) and the generation of a counting event when a person passes through the counting region (70). The same principle is also applicable to objects that are brought through the counting region (70).

The counting region (70) can also be configured as a counting volume 90 (FIG. 9a, b). The person passing the counting volume 90 is then usefully represented by the 3D point cloud 190 they generate.

When the person enters (FIG. 9a) the facility or the vehicle for conveying persons and/or goods, first a point of the 3D point cloud 190 makes its way into the counting volume 90, as time continues more and more points of the 3D point cloud 190, until finally all points of the 3D point cloud 190 can be located in the counting volume 90. As time continues, fewer and fewer points of the 3D point cloud 190 are located in the counting volume 90 because the person traverses the counting volume 90. The distance of the 3D point cloud 190 from the device for detecting, categorizing and counting persons and/or objects 1 is reduced. A counting event is generated exactly when the entire 3D point cloud 190 generated by the person has traversed the counting volume 90, meaning no more points of the 3D point cloud 190 generated by the person can be located within the counting volume 90.

When the person exits (FIG. 9b) the facility or the vehicle for conveying persons and/or goods, first a point of the 3D point cloud 190 makes its way into the counting volume 90, as time continues more and more points of the 3D point cloud 190, until finally all points of the 3D point cloud 190 are located in the counting volume 90. As time continues, fewer and fewer points of the 3D point cloud 190 are located in the counting volume 90 because the person traverses the counting volume 90. The distance of the 3D point cloud 190 from the device for detecting, categorizing and counting persons and/or objects 1 increases. A counting event is generated exactly when the entire 3D point cloud 190 generated by the person has traversed the counting volume 90, meaning no more points of the 3D point cloud 190 generated by the person can be located within the counting volume 90.

The program of the control and evaluation apparatus 60 follows the trajectory of the 3D point cloud 190 over time and thus recognizes whether a person enters or exits the facility or the vehicle.

The counting region (70) can also be defined by two counting areas 80, 81 (FIG. 9c, d) that are arranged parallel to one another and spaced apart from one another. The person passing the counting volume 90 is then usefully represented by a characteristic point 200.

When the person enters (FIG. 9c) the facility or the vehicle for conveying persons and/or goods, the characteristic point 200 penetrates the first counting area 80, and as time continues the second counting area 81. A counting event is generated exactly when the characteristic point 200 has passed the second counting area 81.

When the person exits (FIG. 9d) the facility or the vehicle for conveying persons and/or goods, the characteristic point 200 penetrates the second counting area 81, and as time continues the first counting area 80. A counting event is generated exactly when the characteristic point 200 has passed the first counting area 80.

The program of the control and evaluation apparatus 60 follows the penetration of the sequence of the counting areas 80, 81 over time and thus recognizes whether a person enters or exits the facility or the vehicle.

The counting region (70) can also be defined by one counting area 80 (FIG. 9e, f). The person passing the counting volume 90 is then usefully represented by a characteristic point 200.

When the person enters (FIG. 9e) the facility or the vehicle for conveying persons and/or goods, the characteristic point 200 penetrates the counting area 80; the characteristic point 200 also penetrates the counting area 80 when the person exits (FIG. 9f). A counting event is generated exactly when the characteristic point 200 has passed the counting area 80.

The program of the control and evaluation apparatus 60 follows the trajectory of the characteristic point 200 over time and thus recognizes whether a person enters or exits the facility or the vehicle.

FIG. 10 shows the structure of an exemplary embodiment of the device for detecting, categorizing and counting persons and/or objects 1. The light pattern projector 100 contains the radiation source 10 and optical elements 30 in order to generate the desired light pattern 50 to be projected. One possible embodiment uses a laser diode as the radiation source 10, a collimator lens and a diffractive optical element (DOE) 30. The radiation source 10 generates continuous monochromatic laser radiation S with a wavelength in the range from 780 nm to 1000 nm.

Along with the objective 110 and the bandpass filter 120, the image sensor 130 forms the radiation detector 20. The bandpass filter 120 is only permeable to light in a narrow spectral window. The central wavelength of the bandpass filter 120 corresponds to the wavelength of the light emitted by the radiation source 10. This prevents light of other wavelengths from exposing the image sensor 130. The image data are processed by the control and evaluation apparatus 60 and evaluated by means of a suitable program. The device for detecting, categorizing and counting persons and/or objects 1 is connected for this purpose via an interface to the control and evaluation apparatus 60. The carrier structure 140 brings the radiation detector 20 and the light pattern projector 100 into a defined position and thus realizes what is known as the baseline.

By using the light pattern projector 100, the device for detecting, categorizing and counting persons and/or objects 1 actively provides light and can also work in dark environments. Since the illumination is not over a large area, but rather only light is guided in pattern regions, a smaller light power is necessary than with large-area illumination. Accordingly, less energy is consumed and less waste heat is created.

### LIST OF REFERENCE SIGNS

1 Device for detecting, categorizing and counting persons and/or objects
10 Radiation source
20 Radiation detector
30 Element for deflecting the radiation
40 Detection region
50 Light pattern
60 Control and evaluation apparatus
70 Counting region
80, 81 Counting area
90 Counting volume
100 Light pattern projector
110 Objective
120 Bandpass filter
130 Image sensor
140 Carrier structure
150 Door portal
160 Facility or vehicle for conveying persons and/or goods
170 Person
171 Object
190 Point of the 3D point cloud
200 Characteristic point
S Emitted radiation

1. A method for distinguishing, detecting and counting persons (170) and/or objects (171) in facilities and/or vehicles (160) for conveying persons and/or goods with the following method steps:
Emitting radiation (S) from a radiation source (10)
Deflecting the radiation (S) with an element for deflecting the radiation (30)
Generating a light pattern (50) in a detection region (40)
Detecting the radiation (S) backscattered by persons and/or objects situated in the detection region (40) in a radiation detector (20)
Counting the persons and/or objects in a counting region (70) wherein the counting region (70) is arranged in a region between 30 cm in front of and 30 cm behind an entrance (150) to the facilities and/or to the vehicle for conveying persons and/or objects.

2. The method for distinguishing, detecting and counting persons (170) and/or objects (171) in facilities and/or vehicles (160) for conveying persons and/or goods according to claim 1
characterized in that
the counting region (70) is arranged in a region 20 cm in front of and/or 20 cm behind entrance (150) to the facilities and/or to the vehicle for conveying persons and/or objects and preferably between 10 cm in front of and/or 10 cm behind the entrance (150) to the facilities and/or to the vehicle for conveying persons and/or objects.

3. The method for distinguishing, detecting and counting persons (170) and/or objects (171) in facilities and/or vehicles (160) for conveying persons and/or goods according to claim 1
characterized in that
the counting region (70) comprises a counting volume (90),
wherein a counting event occurs when a person and/or an object enters the counting volume (90) and/or exits the counting volume (90).

4. The method for distinguishing, detecting and counting persons (170) and/or objects (171) in facilities and/or vehicles (160) for conveying persons and/or goods according to claim 1
characterized in that
the counting region (70) comprises a counting area (80, 81),
wherein a counting event occurs when a person and/or an object enters the counting area (80, 81) and/or exits the counting area (80, 81).

5. The method for distinguishing, detecting and counting persons (170) and/or objects (171) in facilities and/or vehicles (160) for conveying persons and/or goods according to claim 1
characterized in that
the counting region (70) comprises two counting areas (80, 81),
wherein a counting event occurs when a person and/or an object enters one of the counting planes (80, 81) and/or exits one of the counting areas (80, 81).

6. The method for distinguishing, detecting and counting persons (170) and/or objects (171) in facilities and/or vehicles (160) for conveying persons and/or goods according to claim 5
characterized in that
a first counting area (80) faces a vehicle interior and a second counting area (81) faces the vehicle exterior,
wherein a counting event occurs when a person and/or an object enters the first counting area (80) and/or exits the second counting area (81).

7. The method for distinguishing, detecting and counting persons (170) and/or objects (171) in facilities and/or vehicles (160) for conveying persons and/or goods according to e claim 1
characterized in that
the location of the counting region (78) and/or of the counting area (81, 80) is chosen depending on the type of detected object.

8. The method for distinguishing, detecting and counting persons (170) and/or objects (171) in facilities and/or vehicles (160) for conveying persons and/or goods according to claim 7
characterized in that
a light pattern (50) is detected in the detection region (40).

9. The method for distinguishing, detecting and counting persons (170) and/or objects (171) in facilities and/or vehicles (160) for conveying persons and/or goods according to claim 8
characterized in that
a shift of the light pattern (50) is detected in the detection region (40).

10. The method for distinguishing, detecting and counting persons (170) and/or objects (171) in facilities and/or vehicles (160) for conveying persons and/or goods according to claim 9
characterized in that
the length of the shift is calculated and a depth value is determined from the length of the shift.

11. The method for distinguishing, detecting and counting persons (170) and/or objects (171) in facilities and/or vehicles (160) for conveying persons and/or goods according to claim 10
characterized in that
the detected synchronously shifted light patterns (50) are compared with characteristic known patterns.

12. The method for distinguishing, detecting and counting persons (170) and/or objects (171) in facilities and/or vehicles (160) for conveying persons and/or goods according to claim 8
characterized in that
the light pattern (50) is assigned to an object type.

13. The method for distinguishing, detecting and counting persons (170) and/or objects (171) in facilities and/or vehicles (160) for conveying persons and/or goods according to claim 1
characterized in that
the counting event is triggered by the entrance and/or the exiting of the counting region (70) and/or of the counting area (80, 81) of the light pattern (50).

14. The method for distinguishing, detecting and counting persons (170) and/or objects (171) in facilities and/or vehicles (160) for conveying persons and/or goods according to claim 1
characterized in that
the method is suitable for distinguishing, detecting and/or counting persons and objects in facilities and/or vehicles for conveying persons and/or goods.

15. The method for distinguishing, detecting and counting persons (170) and/or objects (171) in facilities and/or vehicles (160) for conveying persons and/or goods according to claim 1
characterized in that
the light pattern (50) has a beam density ρₛ of 5*10²/4*π sr⁻¹≤ρₛ≤10⁶/4*π sr⁻¹ preferably at least 1*10³/4*π sr⁻¹ and particularly preferably at least 5*10³/4*π sr⁻¹ and/or preferably maximally 5*10⁵/4*π sr⁻¹ and particularly preferably maximally 1*10⁵/4*π sr⁻¹.

16. A person- and/or object-counting device (1) for detecting, categorizing and counting persons (170) and/or objects (171) in facilities and/or vehicles (160) for conveying passenger and/or goods, comprising:
a radiation source (10),
a radiation detector (20),
an element (30) for deflecting the radiation (S) leaving the radiation source (10)
wherein the element (30) for deflecting the radiation (S) leaving the radiation source (10) is suitable for generating a light pattern (50) in a detection region (40), and
wherein the person- and/or object-counting device is suitable for counting in a counting region (70) persons and/or objects situated therein,
wherein the counting region (70) comprises a sub-region of the detection region (40) and is arranged in a region between 30 cm in front of and 30 cm behind an entrance (150) to the facilities and/or to the vehicle for conveying persons and/or objects.

17. The person- and/or object-counting device (1) for detecting, categorizing and counting persons (170) and/or objects (171) in facilities and/or vehicles (160) for conveying persons and/or goods according to claim 16
characterized in that
the counting region (70) is arranged in a region 20 cm in front of and/or 20 cm behind an entrance (150) of the facility and/or of the vehicle for conveying persons and/or objects and preferably between 10 cm in front of and/or 10 cm behind the entrance (150) to the facilities and/or to the vehicle for conveying persons and/or objects.

18. The person- and/or object-counting device (1) for detecting, categorizing and counting persons (170) and/or objects (171) in facilities and/or vehicles (160) for conveying persons and/or goods according to claim 16
characterized in that
the counting region (70) comprises a counting volume (90),
wherein a counting event occurs when a person and/or an object enters the counting volume (90) and/or exits the counting volume (90).

19. The person- and/or object-counting device (1) for detecting, categorizing and counting persons (170) and/or objects (171) in facilities and/or vehicles (160) for conveying persons and/or goods according to claim 16
characterized in that
the counting region (70) comprises a counting area (80, 81),
wherein a counting event occurs when a person and/or an object enters the counting area (80, 81) and/or exits the counting area (80, 81).

20. The person- and/or object-counting device (1) for detecting, categorizing and counting persons (170) and/or objects (171) in facilities and/or vehicles (160) for conveying persons and/or goods according to claim 16
characterized in that
the counting region (70) comprises two counting areas (80, 81),
wherein a counting event occurs when a person and/or an object enters one of the counting planes (80, 81) and/or exits one of the counting areas (80, 81).

21. The person- and/or object-counting device (1) for detecting, categorizing and counting persons (170) and/or objects (171) in facilities and/or vehicles (160) for conveying persons and/or goods according to claim 20
characterized in that
a first counting area (80) faces the vehicle interior and a second counting area (81) faces the vehicle exterior,
wherein a counting event occurs when a person and/or an object enters the first counting area (80) and/or exits the second counting area (81).

22. The person- and/or object-counting device (1) for detecting, categorizing and counting persons (170) and/or objects (171) in facilities and/or vehicles (160) for conveying persons and/or goods according to claim 16
characterized in that
the location of the counting region (70) and/or of the counting area (80, 81) is chosen depending on the type of detected object.

23. The person- and/or object-counting device (1) for detecting, categorizing and counting persons (170) and/or objects (171) in facilities and/or vehicles (160) for conveying persons and/or goods according to claim 19
characterized in that
the location of the counting areas (80, 81) is predefined.

24. The person- and/or object-counting device (1) for detecting, categorizing and counting persons (170) and/or objects (171) in facilities and/or vehicles (160) for conveying persons and/or goods according to claim 16
characterized in that
the person- and/or object-counting device (1) has an interface to a control and/or evaluation apparatus (60).

25. The person- and/or object-counting device (1) for detecting, categorizing and counting persons (170) and/or objects (171) in facilities and/or vehicles (160) for conveying persons and/or goods according to claim 16
characterized in that
the light pattern (50) has a beam density ρₛ of 5*10²/4*π sr⁻¹≤ρₛ≤10⁶/4*π sr⁻¹ preferably at least 1*10³/4*π sr⁻¹ and particularly preferably at least 5*10³/4*π sr⁻¹ and/or preferably maximally 5*10⁵/4*π sr⁻¹ and particularly preferably maximally 1*10⁵/4*π sr⁻¹.
